(19) United States
(12) Patent Application Publication
(10) Pub. No.: US 2006/0170889 A1
(43) Pub. Date: Aug. 3, 2006

(54) Exposure Apparatus, Manufacturing Method of Optical Element, and Device Manufacturing Method

(75) Inventor: Tokuyuki Honda, Suginami-ku (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Ohta-ku (JP)

(21) Appl. No.: 11/275,914

(22) Filed: Feb. 2, 2006

(30) Foreign Application Priority Data
Feb. 3, 2005 (JP) 2005-027215

(51) Int. Cl. G03B 27/42

(52) U.S. Cl. 355/53; 355/30; 355/67

(57) ABSTRACT

An exposure apparatus includes a projection optical system for projecting an image of a pattern of a reticle onto a substrate via liquid, the liquid being filled in a space between an optical element of the projection optical system and the substrate, the optical element being closest to the substrate in the projection optical system, wherein the optical element includes quartz glass that contacts the liquid and is arranged at a side of the substrate, and fluorine-doped quartz glass adhered to the quartz glass.

### BACKGROUND OF THE INVENTION

The present invention generally relates to an exposure apparatus, and more particularly to an exposure apparatus used to manufacture various types of devices including semiconductor devices, display devices, detecting devices, imaging devices, and a fine pattern for micromechanics. The present invention is suitable for a so-called immersion exposure apparatus that exposes a substrate via a projection optical system and liquid between the projection optical system and the substrate.

A reduction projection exposure apparatus has conventionally been employed which uses a projection optical system to project a circuit pattern onto a wafer, etc., in manufacturing a semiconductor device or a liquid crystal display device in the photolithography technology.

The minimum critical dimension (“CD”) transferable by the reduction projection exposure apparatus or a resolution is proportionate to a wavelength of the exposure light, and inversely proportionate to the numerical aperture (“NA”) of the projection optical system. The shorter the wavelength is, the better the resolution is. Accordingly, use of the exposure light having a shorter wavelength is promoted with recent demands for the fine processing to the semiconductor devices, from a KrF excimer laser (with a wavelength of approximately 248 nm) to an ArF excimer laser (with a wavelength of approximately 193 nm). The next generation light sources, such as an F₂ laser (with a wavelength of approximately 157 nm) and an extremely ultraviolet (EUV) light (with a wavelength of approximately 5-20 nm) are about to reduce to practice.

In this setting, the immersion exposure is one attractive technology to improve the resolution using a light source, such as the ArF excimer laser. The immersion exposure is disclosed, for example, in PCT International Publication No. 99/49504. The immersion exposure fills a space between the final (lens) surface in the projection optical system and the wafer with liquid, shortening the effective wavelength of the exposure light, increasing the apparent NA of the projection optical system, and improving the resolution. Since the NA of the projection optical system is defined as NA=n·sinθ, where n is a refractive index of the liquid, NA can be made larger up to n when the filled material has a refractive index greater than that of the air (n>1).

For example, water has a sufficient transmittance to the ArF excimer laser having the wavelength with approximately 193 nm. Its refractive index is also relatively high or as high as 1.44. Therefore, water is suitable for the immersion-exposure liquid, and it is expected to reduce to practice the immersion exposure apparatus that uses water and the ArF excimer laser as a light source.

One major problem in the immersion exposure apparatus is whether the final lens in the projection optical system can endure long-term use. The immersion exposure apparatus needs to arrange the projection optical system close to the wafer for stable liquid supply to a space between them (or for a formation of a liquid film). Since the energy of the exposure light concentrates on the narrow area in the final lens in the projection optical system so that its intensity becomes locally high, the final lens of the projection optical system changes the density in the long term, affecting the optical characteristics. This is described, for example, in “Verification of compaction and rarefaction models for fused silica with 40 billion pulses of 193-nm excimer laser exposure and their effects on projection lens imaging performance,” J. Martin et al., Proceedings of SPIE, Vol. 5377, pp. 1815-1827 (SPIE, Bellingham, 2004). In addition, there is another problem in which the final lens in the projection optical system contacts the immersion-exposure liquid for a long time period and deteriorates.

Calcium fluoride (CaF₂) and quartz glass are generally known as a viable lens material having a good optical characteristic to the ArF excimer laser having the wavelength of 193 nm. Among them, calcium fluoride dissolves in the water, and thus needs a protective film. However, no protective film has yet been developed which can endure for a long time period under high-intensity ArF excimer laser in the water.

On the other hand, quartz glass has good water resistance but is inferior in transmittance. Thus, it is highly likely to change the glass material density in the long time period and deteriorate the optical characteristic under high-intensity ArF excimer laser irradiations. Fluorine-doped quarts glass could improve the transmittance to the UV light, and reduce the glass material density changes. However, the fluorine atom is likely to react with water. Therefore, when fluorine-doped quarts glass is used for the final lens in the projection optical system that contacts the water, it becomes difficult to guarantee the long-term reliability of the lens.

Thus, none of the conventionally known materials provide sufficient reliability for the final lens material of the projection optical system in the immersion exposure apparatus.

### BRIEF SUMMARY OF THE INVENTION

The present invention is directed to an immersion exposure apparatus that improves the reliability of the final lens in the projection optical system, and provides the good imaging performance.

An exposure apparatus according to one aspect of the present invention includes a projection optical system for projecting an image of a pattern of a reticle onto a substrate via liquid, the liquid being filled in a space between an optical element in the projection optical system and the substrate, the optical element being closest to the substrate in the projection optical system, wherein the optical element includes quartz glass that contacts the liquid and is arranged at a side of the substrate, and fluorine-doped quartz glass adhered to the quartz glass.

A manufacturing method of an optical element according to another aspect of the present invention in a projection optical system for an exposure apparatus, the projection optical system projecting an image of a pattern of a reticle onto a substrate via liquid, the liquid being filled in a space between the optical element in the projection optical system and the substrate, the optical element being closest to the substrate in the projection optical system includes the steps of processing fluorine-doped quartz glass into a lens shape, and forming quartz glass on the fluorine-doped quartz glass processed by the processing step.

A manufacturing method of an optical element according to still another aspect of the present invention in a projection optical system for an exposure apparatus, the projection optical system projecting an image of a pattern of a reticle onto a substrate via liquid, the liquid being filled in a space between the optical element in the projection optical system and the substrate, the optical element being closest to the substrate in the projection optical system includes the step of sticking fluorine-doped quartz glass that is processed into a lens shape, with quartz glass.

A device manufacturing method according to still another aspect of the present invention includes the steps of exposing an substrate using the above exposure apparatus, and developing the substrate that has been exposed.

Other objects and further features of the present invention will become readily apparent from the following description of the preferred embodiments with reference to the accompanying drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic sectional view of an exposure apparatus according to one aspect of the present invention.

FIG. 2 is an enlarged view of a structure of a final optical element in a projection optical system shown in FIG. 1.

FIG. 3 is a flowchart for explaining manufacture of devices (such as semiconductor chips such as ICs and LCDs, CCDs, and the like).

FIG. 4 is a detail flowchart of a wafer process as Step 4 shown in FIG. 3.

### DETAILED DESCRIPTION OF THE PREFERRED EMBODIMENTS

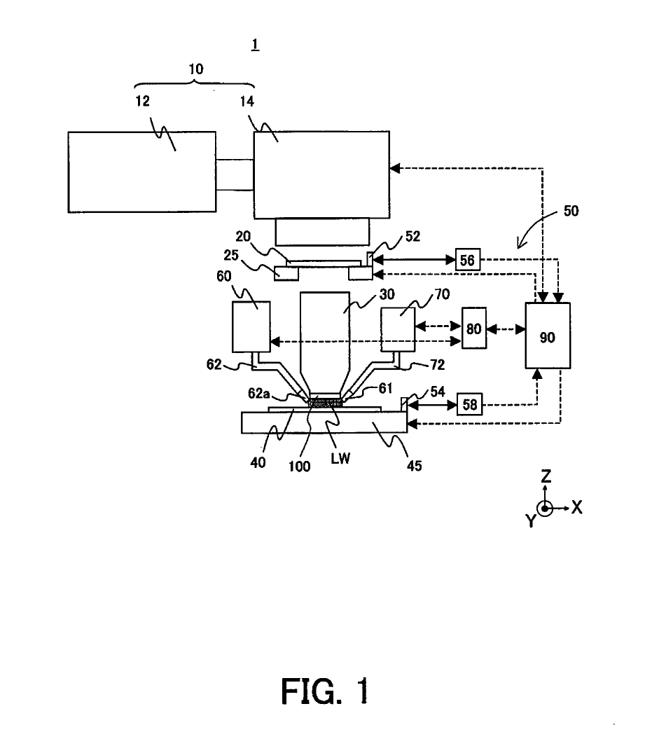

Referring now to the accompanying drawings, a description will now be given of an exposure apparatus 1 according to one aspect of the present invention. In each figure, like elements are designated by the same reference numerals, and a duplicate description thereof will be omitted. Here, FIG. 1 is a schematic sectional view of the illustrative inventive exposure apparatus 1.

The exposure apparatus 1 is an immersion projection exposure apparatus that exposes onto a substrate 40 an image of a circuit pattern in a step-and-scan manner, via liquid LW supplied between the substrate 40 and the final optical element (or final lens) 100. The “step-and-scan manner,” as used herein, is an exposure method that exposes a mask pattern onto a wafer by continuously scanning the wafer relative to the mask, and by moving, after a shot of exposure, the wafer stepwise to the next exposure area to be shot.

The exposure apparatus 1 includes, as shown in FIG. 1, an illumination apparatus 10, a reticle stage 25, a projection optical system 30, a wafer stage 45, a distance-measuring means 50, a liquid supply unit 60, a liquid recovery unit 70, an immersion controller 80, and a controller 90.

The illumination apparatus 10 illuminates a reticle (or mask) 20 that has a circuit pattern to be transferred, and includes a light source unit 12, and an illumination optical system 14.

The light source unit 12 uses as a light source an ArF excimer laser with a wavelength of 193 nm. However, the light source unit 12 is not limited to the ArF excimer laser and may use, for example, a KrF excimer laser, and an F₂ laser. In addition, the number of laser units is not limited.

The illumination optical system 14 is an optical system that illuminates the reticle 20, and includes a lens, a mirror, an optical integrator, a aperture stop, and the like, for example, in order of a condenser lens, a fly-eye lens, an aperture stop, a condenser lens, a slit and an imaging optical system. The optical integrator may include a fly-eye lens or an integrator formed by stacking two sets of cylindrical lens array plates (or lenticular lenses), and can be replaced with an optical rod, a diffractive element, or a micro-lens-array.

The reticle 20 is fed from the outside of the exposure apparatus 1 by a reticle feed system (not shown), and is supported and driven by the reticle stage 25. The reticle 20 is made, for example, of quartz, and has a circuit pattern to be transferred. The diffracted light emitted from the reticle 20 passes the projection optical system 30, and is projected onto the substrate 40. The reticle 20 and the substrate 40 are located in an optically conjugate relationship. Since the exposure apparatus 1 of this embodiment is a scanner, the reticle 20 and the substrate 40 are scanned at the speed ratio of the reduction ratio, thus transferring the pattern on the reticle 20 to the substrate 40. While this embodiment uses the step-and-scan exposure apparatus (scanner), the present invention may use a repeat-and-step exposure apparatus (stepper). In this case, the reticle 20 and the substrate 40 are maintained stationary during exposure.

The reticle stage 25 is attached to a stool (not shown). The reticle stage 25 supports the reticle 20 via a reticle chuck (not shown), and its movement is controlled by a moving mechanism (not shown) and the controller 90. The moving mechanism (not shown) includes a linear motor, etc., and drives the reticle stage 25 to move the reticle 20 in the XYZ directions.

The projection optical system 30 is an optical system that serves to image the diffracted light from the pattern of the reticle 20. The projection optical system 30 may use a dioptric system solely including a plurality of lenses, and a catadioptric system including a plurality of lenses and at least one mirror, and so on.

The substrate 40 is fed from the outside of the exposure apparatus 1 by a wafer fed system (not shown), and supported and driven by the wafer stage 45. The substrate 40 is a wafer in this embodiment, but may broadly cover a glassplate and an object to be exposed. A photoresist is applied onto the substrate 40.

The wafer stage 45 supports the substrate 40 via a wafer chuck. The wafer stage 45 serves to adjust a position in the vertical or longitudinal direction, a rotational direction and an inclination of the substrate 40, under control of the controller 90. During exposure, the controller 90 controls the wafer stage 45 so that the surface of the substrate 40 (exposure area) always accords with the imaging plane of the projection optical system 30 with high precision.

The distance-measuring means 50 measures a position of the reticle stage 25, a two-dimensional position of the wafer stage 45 on real-time basis, via reference mirrors 52 and 54, and laser interferometers 56 and 58. The distance measurement result by the distance-measuring means 50 is transmitted to the controller 90, and the reticle stage 25 and the wafer stage 45 are driven at a constant speed ratio under control of the controller 90 for positioning and synchronous control.

The liquid supply unit 60 serves to supply the liquid LW into the space between the projection optical system 30 and the substrate 40, and includes a generation means (not shown) and a liquid supply nozzle 62. In other words, the liquid supply unit 60 supplies the liquid LW via a supply port 62a of the liquid supply nozzle 62 arranged around the final optical element 100 in the projection optical system 30, and forms a liquid film of the liquid LW in the space between the projection optical system and the substrate 40. The space between the projection optical system and the substrate 40 preferably has a thickness, for example, of 5 mm or smaller, enough to stably form and remove the liquid film of the liquid LW.

The liquid LW serves to improve the resolution in the exposure by shortening the equivalent exposure wavelength of the exposure light from the light source unit 12. The liquid LW is pure water in this embodiment. The large amount of pure water is generally used for the semiconductor device manufacturing process. However, the liquid LW is not specifically limited to the pure water. Any liquid may be used as long as it has high light transmission characteristic and refraction index characteristic to the wavelength of the exposure light and it is chemically stable to the photoresist applied to the substrate 40 and the final optical element 100 in the projection optical system 30. For example, the liquid LW may use so-called functional water that is made by adding a small amount of additive to the pure water. By changing the type and concentration of the additive, the functional water can advantageously control the acidity and optimize the chemical reaction process of the photoresist, or control the oxidation-reduction potential and provide cleansing power.

The generation mechanism reduces contaminants, such as metal ions, fine particles, and organic matters, from material water supplied from a material water source, generating the liquid LW. The liquid LW generated by the generation mechanism is supplied to the liquid supply nozzle 62. While the generation mechanism supplies the liquid LW to the liquid supply nozzle 62, degas means and temperature control means may provide degas and temperature control to the liquid LW.

The liquid supply nozzle 62 supplies the liquid LW generated by the generation mechanism to the space between the projection optical system 30 and the substrate 40. The liquid supply nozzle 62 is preferably made of a material that does not dissolve contaminants and has sufficient durability to the liquid LW, such as fluorine resin etc.

The liquid recovery unit 70 recovers the liquid LW that has been supplied to the space between the projection optical system 30 and the substrate 40, via a recovery port 72a of a liquid recovery nozzle 72. The liquid recovery unit 70 includes, for example, a liquid recovery nozzle 72, a tank that temporarily stores the stored liquid LW, and a suction unit that sucks the liquid LW.

The immersion controller 80 obtains information of the wafer stage 45, such as a current position, a speed, acceleration, a substrate position, and a moving direction, and controls the immersion exposure based on the information. The immersion controller 80 provides the liquid supply unit 60 and the liquid recovery unit 70 with control commands, such as a switch between supplying and recovering of the liquid LW, a stop of the supply of the liquid LW, a stop of the recovery of the liquid LW, and control over the amounts of the supplied or recovered liquid LW.

The controller 90 includes a CPU and a memory (not shown), and controls operations of the exposure apparatus 1. The controller 90 is electrically connected to the illumination apparatus 10, the reticle stage 25 (or the moving mechanism (not shown) of the reticle stage 25), the wafer stage 45 (or the moving mechanism (not shown) of the wafer stage 45), and the immersion controller 80. The CPU includes any processor irrespective of its name, such as an MPU, and controls operations of each component. The memory includes a ROM and a RAM, and stores firmware that operates the exposure apparatus 1. While this embodiment separately includes the immersion controller 80 and the controller 90, the controller 90 may serve as the immersion controller 80.

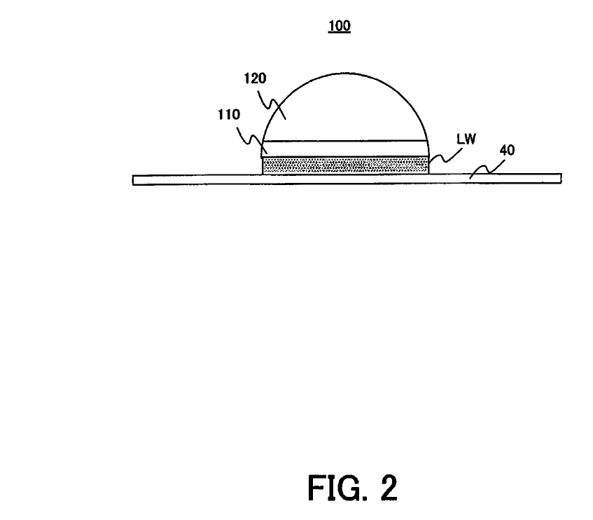

A description will now be given of a final optical element 100 that contacts the liquid LW and is closest to the substrate 40 in the projection optical system 30. FIG. 2 is an enlarged sectional view of a structure of the final optical element in the projection optical system 30. The final optical element 100 is a lens in this embodiment, and has two types of materials, i.e., quartz glass 110 and fluorine-doped quartz glass 120. The quartz glass 110 is arranged at the side of the substrate 40, and contacts the liquid LW.

The quartz glass 110 is chemically stable to the liquid LW, such as pure water and various types of functional waters, and can prevent deteriorations of the optical characteristic that would otherwise occur when the final optical element 100 contacts the liquid LW. The fluorine-doped quartz glass 120 has a good transmittance to the ArF excimer laser having a wavelength of 193 nm, and is less likely to deteriorate the optical characteristic due to the density changes caused by the laser light irradiations than a lens that has solely the quartz glass 110. See H. Hosono, M. Mizuguchi, L. Skuja and T. Ogawa: Optics Letters Vol. 24 (1999) pp. 1549-1551. The fluorine doping amount in the fluorine-doped quartz glass 120 may be, for example, between 0.1 mol % to 10 mol %. The quartz glass 110 and the fluoride-doped quartz glass 120 have almost the same coefficient of linear thermal expansion. Therefore, the final optical element 100 has an advantage in having reduced stress changes due to the temperature change.

An increased ratio of the fluorine-doped quartz glass 120 having a good transmittance provides the final optical element 100 with reduced influence of imaging characteristic due to the density changes of the glass material. Thus, the thickness of the quartz glass 110 in the optical-axis direction is preferably maintained half the thickness of the final optical element 120 or smaller. On the other hand, in order to protect the fluorine-doped quartz glass 120 from the liquid LW, it is preferable to make sufficiently thick the quartz glass 110 that contacts the liquid LW. Among other things, the molecular dispersion is one cause of the glass-material deterioration due to the contact with the liquid LW. According to the universally known Fick's law of diffusion, the molecular dispersion speed is inversely proportionate to the about square of the thickness of the quartz glass 110. The maximum extended life of 5 years is reported as a result of use of a quartz glass film or a similar oxide glass film as a protective film for a calcium fluoride lens. See Liberman et al., International Symposium on Immersion and 157 nm Lithography, SEMATECH (2004). Assuming that the life of the normal exposure apparatus is about 20 years, the quartz glass 110 preferably has a thickness of 1 μm or greater.

A description will now be given of a manufacturing method of manufacturing the final optical element (lens) 100 made of the quartz glass 110 and the fluorine-doped quartz glass 120. A first manufacturing method uses ion sputtering etc. to form the quartz glass 110 as a film on the fluorine-doped quartz glass 120 that is processed into a lens shape. A second method sticks the quartz glass 110 as a bulk material with the fluorine-doped quartz glass 120 using adhesive agent. Use of the quartz glass 110 as a bulk material easily provides a sufficient thickness.

Further, as a third method, the quartz glass 110 as a bulk material may be stuck with the fluorine-doped quartz glass 120 through optical contact. The quartz glass 110 and the fluorine-doped quartz glass 120 have almost the same coefficient of linear thermal expansion and good adherence. Hence, they are suitable for the optical contact. The optical contact is conventionally used in the manufacturing process of the optical element. See Warren J. Smith: “Modern Optical Engineering,” Second Edition, McGraw-Hill (1990) pp. 201. Sticking between the quartz glass 110 and the fluorine-doped quartz glass 120 through the optical contact has an advantage in reduced deteriorations at the joint and reduced degas.

Thus, the final optical element 100 in the projection optical system 30 can prevent deteriorations of the density changes caused by the laser light irradiations and the glass material due to the contact with the liquid LW. In other words, the final optical element 100 in the projection optical system 30 has sufficient reliability as a final lens in the projection optical system in the immersion exposure apparatus.

In exposure, the illumination optical system 14 e.g., Koehler-illuminates the reticle 20 using the light emitted from the light source unit 12. The light that passes the reticle 20 and reflects the reticle pattern is imaged on the substrate 40 by the projection optical system 30 and the liquid LW. Since the projection optical system 30 in the exposure apparatus 1 uses the final optical element 100 that prevents deteriorations due to the density changes caused by the laser beam irradiations and the contact with the liquid LW, the exposure apparatus 1 can expose the pattern of the reticle 20 at a high resolution. Thereby, the exposure apparatus 1 can provide devices (such as semiconductor devices, LCD devices, image pickup devices (such as CCDs, etc.), thin film magnetic heads, and the like) at a high throughput and economical efficiency.

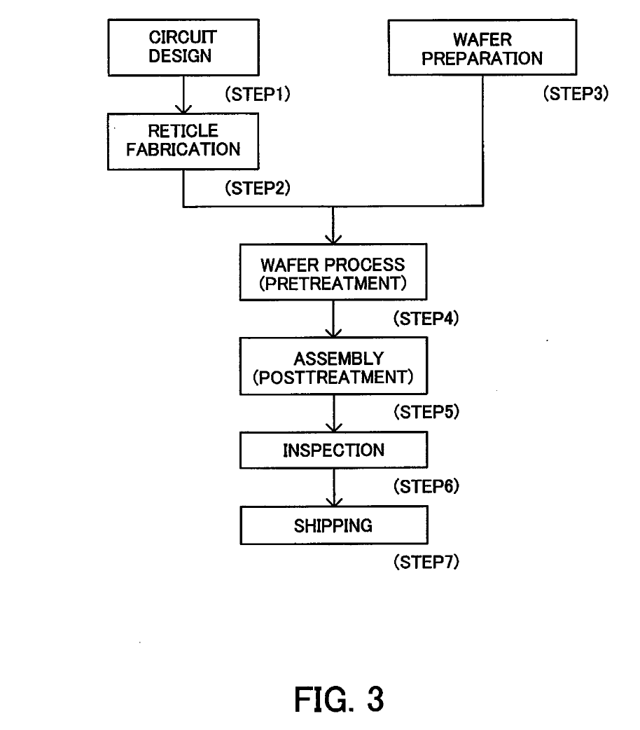

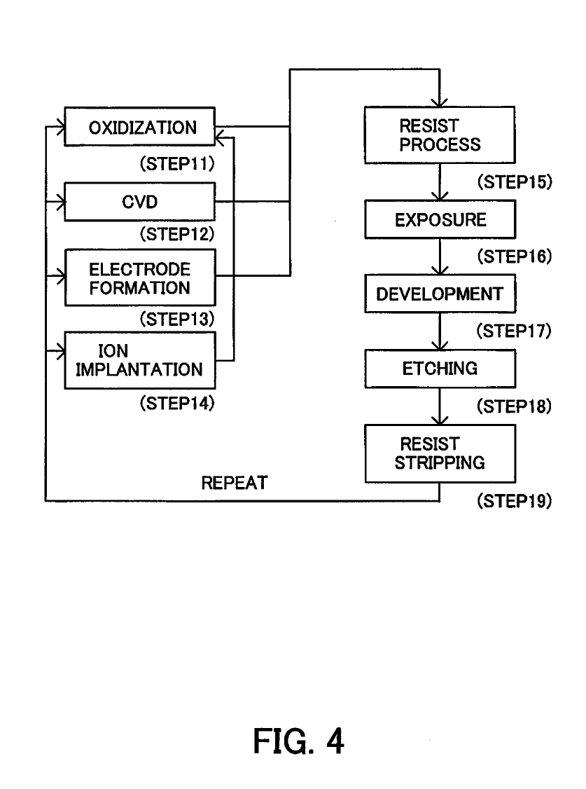

Referring now to FIGS. 3 and 4, a description will be given of an embodiment of a device manufacturing method using the above exposure apparatus 1. FIG. 3 is a flowchart for explaining how to fabricate devices (i.e., semiconductor chips such as IC and LSI, LCDs, CCDs, and the like). Here, a description will be given of the fabrication of a semiconductor chip as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms actual circuitry on the wafer through lithography using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 4 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern of the reticle onto the wafer. Step 17 (development) develops the exposed wafer. Step 18 (etching) etches parts other than a developed resist image. Step 19 (resist removing) removes disused resist after etching. These steps are repeated, and multi-layer circuit patterns are formed on the wafer. Use of the manufacturing method in this embodiment helps fabricate higher-quality devices than ever. The device manufacturing method that uses the exposure apparatus 1 and resultant devices constitute one aspect of the present invention.

Further, the present invention is not limited to these preferred embodiments, and various variations and modifications may be made without departing from the scope of the present invention.

This application claims a foreign priority benefit based on Japanese Patent Application No. 2005-027215 filed on Feb. 3, 2005, which is hereby incorporated by reference herein in its entirety as if fully set forth herein.

What is claimed is:

1. An exposure apparatus comprising:
a projection optical system for projecting an image of a pattern of a reticle onto a substrate via liquid, the liquid being filled in a space between an optical element in the projection optical system and the substrate, the optical element being closest to the substrate in the projection optical system,
wherein the optical element includes:
quartz glass that contacts the liquid and is arranged at a side of the substrate; and
fluorine-doped quartz glass adhered to the quartz glass.

2. An exposure apparatus according to claim 1, wherein the quartz glass optically contacts the fluorine-doped quartz glass.

3. An exposure apparatus according to claim 1, wherein the quartz glass has a thickness of 1 μm or greater in an optical-axis direction and half a thickness of the optical element or smaller.

4. A manufacturing method of an optical element in a projection optical system for an exposure apparatus, the projection optical system projecting an image of a pattern of a reticle onto a substrate via liquid, the liquid being filled in a space between the optical element in the projection optical system and the substrate, the optical element being closest to the substrate in the projection optical system, said manufacturing method comprising the steps of:
processing fluorine-doped quartz glass into a lens shape; and
forming quartz glass on the fluorine-doped quartz glass processed by said processing step.

5. A manufacturing method of an optical element in a projection optical system for an exposure apparatus, the projection optical system projecting an image of a pattern of a reticle onto a substrate via liquid, the liquid being filled in a space between the optical element in the projection optical system and the substrate, the optical element being closest to the substrate in the projection optical system, said manufacturing method comprising the step of sticking fluorine-doped quartz glass that is processed into a lens shape, with quartz glass.

6. A manufacturing method according to claim 5, said sticking step uses adhesive agent.

7. A manufacturing method according to claim 5, said sticking step uses optical contact.

8. A device manufacturing method comprising the steps of:
exposing a substrate using an exposure apparatus according to claim 1; and
developing the substrate that has been exposed.
